(19) United States
(12) Patent Application Publication
(10) Pub. No.: US 2024/0035327 A1
(43) Pub. Date: Feb. 1, 2024

(54) Panel

(71) Applicant: APPLE INC., Cupertino, CA (US)

(72) Inventors: Trevor M. Sultana, Mountain View, CA (US); Ali Tavakoli Targhi, San Jose, CA (US); Steven H. Klotz, Austin, TX (US); Moshe J. Baum, Merritt Island, FL (US); Donald R. Monroe, Los Gatos, CA (US)

(21) Appl. No.: 18/377,695

(22) Filed: Oct. 6, 2023

Related U.S. Application Data
(63) Continuation of application No. PCT/US2022/028734, filed on May 11, 2022.
(60) Provisional application No. 63/197,902, filed on Jun. 7, 2021.

(51) Int. Cl. E05F 7/00; B60J 1/16; B60J 5/04; B60J 10/74; E05D 15/20; E05F 15/689

(52) U.S. Cl. CPC E05F 7/00; B60J 1/16; B60J 5/0402; B60J 5/0412; B60J 10/74; E05D 15/20; E05F 15/689; E05Y 2201/64; E05Y 2201/684; E05Y 2201/222

(57) ABSTRACT

A first portion and a second portion cooperate to define an opening. Guide structures are in engagement with bracket assemblies so that the bracket assemblies are movable with respect to the guide structures to allow movement of a panel between a closed position and an open position. A stabilizer engages the panel in the open position. In some implementations, the panel may be flush relative to the first portion and/or the second portion in the closed position.

### CROSS-REFERENCE TO RELATED APPLICATIONS

This application is a continuation of International Application No. PCT/US2022/028734, filed on May 11, 2022, which claims the benefit of U.S. Patent Application No. 63/197,902, filed on Jun. 7, 2021, content of which are hereby incorporated by reference in their entireties for all purposes.

### TECHNICAL FIELD

This disclosure relates to panels.

### BACKGROUND

Some panels can be moved between a closed position. Such panels include drop glass panels.

### SUMMARY

A first aspect of the disclosure is a vehicle includes a first vehicle body portion, a second vehicle body portion, and a window. The first vehicle body portion and the second vehicle body portion cooperate to define a window opening. The vehicle also includes a window that has window surface and bracket assemblies that are connected to the window. The vehicle also includes guide structures that are in engagement with the bracket assemblies so that the bracket assemblies are movable with respect to the guide structures to allow movement of the window between a closed position and an open position. The vehicle also includes a stabilizer that is connected to the second vehicle body portion and engages the window surface of the window when the window is in the open position.

In some implementations of the vehicle according to the first aspect of the disclosure, the stabilizer includes a contact member that is biased toward engagement with the window surface of the window when the window is in the open position. In some implementations of the vehicle according to the first aspect of the disclosure, the guide structures include a first guide structure and a second guide structure, wherein the stabilizer is located between the first guide structure and the second guide structure. In some implementations of the vehicle according to the first aspect of the disclosure, the second vehicle body portion defines an interior space, the guide structures are located inside the interior space of the second vehicle body portion, the stabilizer is located inside the interior space of the second vehicle body portion, and the window is located inside the second vehicle body portion when the window is in the open position. In some implementations of the vehicle according to the first aspect of the disclosure, the guide structures each include a first guide and a second guide, and the bracket assemblies each include a first follower that is movable along the first guide and a second follower that is movable along the second guide. In some implementations of the vehicle according to the first aspect of the disclosure, the first guide and the second guide of each of the guide structures are tracks.

In some implementations of the vehicle according to the first aspect of the disclosure, the first vehicle body portion is an upper portion of a door and the second vehicle body portion is a lower portion of the door. In some implementations of the vehicle according to the first aspect of the disclosure, the first vehicle body portion includes a door pillar and the second vehicle body portion is a door.

In some implementations of the vehicle according to the first aspect of the disclosure, the window includes a panel that is at least translucent and a seal, the seal is located along a peripheral edge of the window, and the seal is in engagement with the first vehicle body portion and the second vehicle body portion when the window is in the closed position. In some implementations of the vehicle according to the first aspect of the disclosure, the first vehicle body portion includes a first body surface portion, the second vehicle body portion includes a second body surface portion, and the window surface of the window is flush relative to the first body surface portion and the second body surface portion when the window is in the closed position. In some implementations of the vehicle according to the first aspect of the disclosure, the vehicle includes an actuation assembly that is configured to cause movement of the window between the closed position and the open position.

A second aspect of the disclosure is a vehicle that includes a door and a window. The door defines a window opening and an interior space. The window has window surface, wherein the window is movable with respect to the door between a closed position and an open position, the window occupies the window opening when the window is in the closed position, and the window is located inside the interior space of the door when the window is in the open position. The vehicle also includes a first bracket assembly, a second bracket assembly, a first guide structure and a second guide structure. The first bracket assembly moves along the first guide structure and the second bracket assembly moves along the second guide structure during movement of the window between the closed position and the open position. The vehicle also includes an actuation assembly that is configured to cause movement of the window between the closed position and the open position. The vehicle also includes a stabilizer that is connected to the door and engages the window surface of the window when the window is in the open position.

In some implementations of the vehicle according to the second aspect of the disclosure, the stabilizer includes a contact member that is biased toward engagement with the window surface of the window when the window is in the open position. In some implementations of the vehicle according to the second aspect of the disclosure, the stabilizer is located between the first guide structure and the second guide structure. In some implementations of the vehicle according to the second aspect of the disclosure, the stabilizer is located inside the interior space of the door. In some implementations of the vehicle according to the second aspect of the disclosure, the first bracket assembly and the second bracket assembly each include followers, the first guide structure and the second guide structure each include guides, the followers of each of the first bracket assembly and the second bracket assembly are in engagement with the guides of a respective one of the first guide structure and the second guide structure to allow movement of the first bracket assembly and the second bracket assembly with respect to the first guide structure and the second guide structure. In some implementations of the vehicle according to the second aspect of the disclosure, the door defines a door surface portion and the window surface of the window is flush relative to the door surface portion when the window is in the closed position.

A third aspect of the disclosure is a vehicle that includes a vehicle body portion that defines a door opening and a door that defines an interior space. The door is connected to the vehicle body portion, the door is positionable in the door opening, and the vehicle body portion and the door cooperate to define a window opening. The vehicle also includes a window that is movable between a closed position and an open position and bracket assemblies that are connected to the window. The vehicle also includes guide structures that are located in the interior space of the door, wherein the bracket assemblies move along the guide structures during movement of the window between the closed position and the open position. The vehicle also includes an actuation assembly that is configured to cause movement of the window between the closed position and the open position. The vehicle also includes a stabilizer that is connected to the door and engages a window surface of the window when the window is in the open position.

In some implementations of the vehicle according to the third aspect of the disclosure, the stabilizer includes a contact member that is biased toward engagement with the window surface of the window when the window is in the open position. In some implementations of the vehicle according to the second aspect of the disclosure, the stabilizer is located inside the interior space of the door. In some implementations of the vehicle according to the third aspect of the disclosure, the guide structures each include a first track and a second track, the bracket assemblies each include a first follower that engages the first track of a respective one of the guide structures and a second follower that engages the second track of the respective one of the guide structures. In some implementations of the vehicle according to the third aspect of the disclosure, the vehicle body portion includes a body surface portion, the door includes a door surface portion, and the window surface of the window is flush relative to the body surface portion and the door surface portion when the window is in the closed position.

### BRIEF DESCRIPTION OF THE DRAWINGS

FIG. 1 is an illustration of part of a vehicle.

FIG. 2 is an illustration of a window.

FIG. 3 is a cross-section illustration of the vehicle taken along line A-A of FIG. 1 showing the window in a closed position.

FIG. 4 is a cross-section illustration of the vehicle taken along line A-A of FIG. 1 showing the window in the open position.

FIG. 5 is an illustration showing part of a guide structure.

FIG. 6 is a cross-section illustration of the guide structure and a bracket assembly taken along line B-B of FIG. 4.

FIG. 7 is a cross-section illustration showing a stabilizer when the window is in the closed position.

FIG. 8 is a cross-section illustration showing the stabilizer when the window is in the open position.

FIG. 9 is an illustration of part of a vehicle according to an alternative implementation.

FIG. 10 is an illustration of part of a vehicle according to an alternative implementation.

FIG. 11 is a block diagram that shows an implementation of the vehicle.

FIG. 12 is a block diagram that shows an implementation of a control system of the vehicle.

### DETAILED DESCRIPTION

This disclosure is directed to a vehicle having windows that move from a closed position to an open position. This may be referred to as movement of the window from a raised position to a lowered position in some implementations. The windows described herein are of the type that are included in a door of the vehicle and move downward relative to a window opening and into an interior space that is defined in the door during movement of the window between the closed position to the open position. The windows described herein may, however, be used in vehicle applications other than doors, and may move in other directions between the closed and open positions.

In typical vehicle window designs windows are typically inset relative to body panels to allow them to translate into a space inside the door or other portion of a vehicle body. As one example, flat windows may translate linearly along tracks from a closed position to an open position. As another example, curved windows are typically shaped according to a constant radius arc, which results in a window having a shape that is a portion of a cylinder surface and the volume through which the window moves into the vehicle body during movement from the closed position to the open position lies along the same constant radius arc.

The windows described herein are supported using brackets and guide structures that allow for complex motion of the window and complex shapes for the window, as opposed to motion and shapes that are dictated by linear translation or constant radius translation, as is the case in some common window designs. This complex motion allows an outer surface of the window to be positioned flush relative to surrounding surfaces of the vehicle body when the window is in the closed position. The bracket assemblies and guide structures are located near side edges of the window and the bracket assemblies are connected to the window near a lower edge of the window. To further support the window in the open position, a stabilizer is connected to the door and is located inside the interior space of the door so that it engages the window surface of the window when the window is in the open position.

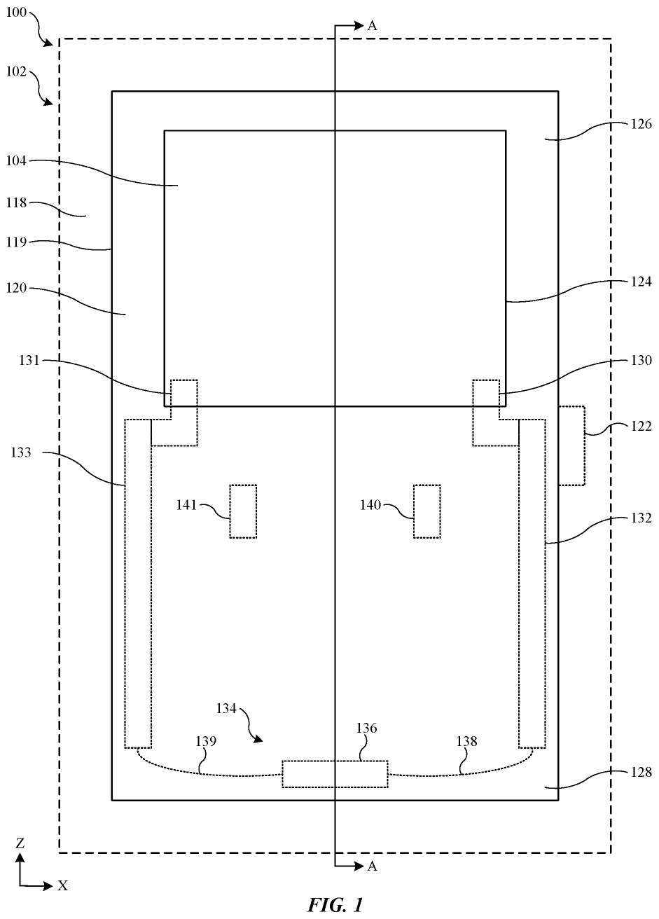

FIG. 1 is an illustration of part of a vehicle 100 that includes a vehicle body 102 and shows a window 104 in a closed position. The window 104 is movable to an open position as will be discussed further herein. The vehicle 100 may be a road going vehicle that includes features that are typically found in conventional examples of such vehicles. As an example, the vehicle body 102 may be part of a sprung mass of the vehicle 100 that is supported with respect to a surface (e.g., a road surface) by wheels, tires, suspension components, and other conventional components that are included in an unsprung mass of the vehicle. These and other conventional vehicle components are not shown in FIG. 1 for clarity.

The vehicle body 102 includes interior and exterior components of the vehicle 100 including components that are structural and/or aesthetic in nature. The vehicle body 102 extends in a longitudinal direction X (e.g., front-to-back), a lateral direction Y (e.g., side-to-side, not shown in FIG. 1), and in an elevational direction Z (e.g., top-to-bottom). The vehicle body 102 defines a vehicle interior (not shown) of the vehicle 100, such as a passenger compartment and/or a cargo compartment.

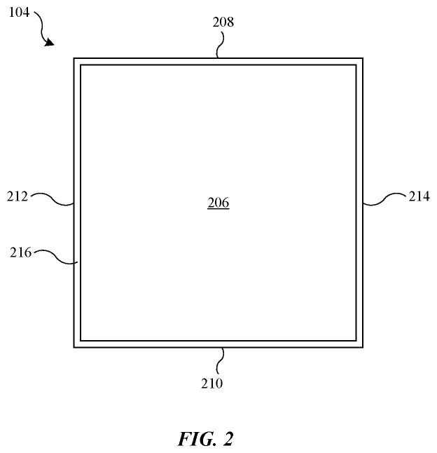

FIG. 2 is an illustration that shows the window 104. The window 104 is at least translucent in that part of or all of the window 104 is formed from a material, such as glass or plastic, that permits transmission of light through it (e.g., a panel formed from an at least translucent material). As used herein, the term at least translucent includes both translucent and transparent materials. The window 104 includes a window surface 206 that extends to an outer periphery of the window 104. The outer periphery of the window 104 includes an upper edge 208, a lower edge 210, a first side edge 212, and a second side edge 214 in the illustrated implementation. The window 104 also includes a seal 216 that is located at the outer periphery of the window 104 and is formed from a compliant material to seal the window 104 relative to portions of the vehicle body 102 in order to resist admission of air and water into the vehicle 100. Thus, the seal 216 may be located along a peripheral edge of the window 104 that is defined by the upper edge 208, the lower edge 210, the first side edge 212, and the second side edge 214 of the window 104. The seal 216 may be molded onto the remainder of the window 104 (e.g., onto the panel that is formed from at least translucent glass or plastic). In some implementations, the seal 216 may have a configuration that further enhances engagement and sealing with respect to adjacent structures, such as portions of the vehicle body 102. As one example, part of the seal 216 may be articulatable with respect to the window 104. As another example, the seal 216 may be inflatable (e.g., with a supply of air under pressure) to expand the seal 216 volumetrically for enhanced engagement with adjacent structures.

With further reference to FIG. 1, the vehicle body 102 includes a side portion 118 and a door 120. The side portion 118 may be part of a side of the vehicle 100 and may be referred to as a wall, side wall, or side portion of the vehicle body 102. The side portion 118 defines a door opening 119. The door 120 is movable between closed and open positions with respect to the vehicle body 102 to allow access to the vehicle interior of the vehicle 100 through the door opening 119. A connecting structure 122 connects the door 120 to the side portion 118 in a manner that allows movement of the door 120 between the open and closed positions. Any suitable structure may be used as the connecting structure 122 such as a conventional pivoting door hinge mechanism to allow the door 120 to pivot with respect to the side portion 118 between the open and closed positions or a conventional sliding door mechanism assembly to allow the door 120 to slide with respect to the side portion 118 between the open and closed positions.

A window opening 124 is formed through the door 120. In the illustrated implementation, the door 120 includes an upper portion 126 and a lower portion 128. The upper portion 126 is a window frame and the lower portion is a main portion of the door 120. The upper portion 126 is adjacent to an upper edge of the window 104 and is also adjacent to side edges of the window 104 when the window 104 is in the closed position. The lower portion 128 of the door 120 is adjacent to a lower edge of the window 104 when the window 104 is in the closed position. The window 104 is also flush relative to portions of the upper portion 126 of the door 120 and the lower portion 128 of the door 120 in the closed position. For example, the window 104 may be flush relative to a first vehicle body surface portion that is defined on the upper portion 126 of the door 120 and may be flush relative to a second vehicle body surface portion that is defined on the lower portion 128 of the door 120 in the closed position.

In the illustrated implementation, the window 104 is connected to the door 120. The window 104 occupies the window opening 124 when the window 104 is in the closed position. To move the window 104 between the closed position and the open position, the vehicle 100 includes bracket assemblies 130, 131 (e.g., a first bracket assembly and a second bracket assembly) that are connected to the window 104, and guide structures 132, 133 (e.g., a first guide structure and a second guide structure) that are connected to the door 120. The guide structures 132, 133 are in engagement with the bracket assemblies 130, 131 so that the bracket assemblies 130, 131 are movable with respect to the guide structures 132, 133. For example, the bracket assemblies 130, 131 may slide along the guide structures 132, 133 to allow movement of the window 104 between the closed position and the open position.

In the illustrated example, the bracket assemblies 130, 131 are both located near the lower edge of the window 104 and are each located near a respective side edge of the window 104. Thus, in the illustrated implementation, the first and second bracket assemblies are generally aligned in the elevational direction Z of the vehicle 100 and are spaced from each other in the longitudinal direction X of the vehicle 100. Similarly, the guide structures 132, 133 in the illustrated example are paired with respective ones of the bracket assemblies 130, 131 and are therefore positioned in alignment with each other in the elevational direction Z of the vehicle 100 and are spaced from each other in the longitudinal direction of the vehicle 100. In the illustrated implementation, the first bracket assembly and second bracket assembly of the bracket assemblies 130, 131 are positioned outward relative to the side edges of the window 104, with the first bracket assembly and the second bracket assembly of the bracket assemblies 130, 131 being located outward relative to opposite side edges of the window 104 as shown in the illustrated implementation. The first bracket assembly and second bracket assembly of the bracket assemblies 130, 131 may instead be positioned inward relative to the side edges of the window 104, with the first bracket assembly and the second bracket assembly of the bracket assemblies 130, 131 being located inward relative to opposite side edges of the window 104.

An actuator assembly 134 is connected to the door 120 and is configured to cause movement of the window 104 between the closed position and the open position. In the illustrated implementation, the actuator assembly 134 includes an actuator 136 and push-pull cables 138, 139 that are connected to the actuator and to the bracket assemblies 130, 131 to move the bracket assemblies 130, 131 along the guide structures 132, 133 and thereby move the window 104 between the closed and open positions. As an example, the actuator 136 may be a rotary electric motor that extends and retracts the push-pull cables 138, 139 (e.g., from a spool). Other actuator configurations may be used. In the illustrated implementation, the actuator 136 extends and retracts both of the push-pull cables 138, 139, but separate actuators may be used instead.

The vehicle 100 also includes stabilizers 140, 141 (e.g., a first stabilizer and a second stabilizer) that are connected to door 120 to stabilize the window 104 when the window 104 is in the open position. As an example, the stabilizers 140, 141 may be configured to engage the window 104 to restrain movement of the window 104 with respect to the door 120 when the window 104 is in the open position. The stabilizers 140, 141 are located in the interior space 121 of the door 120 between the guide structures 132, 133 and are positioned so that they are spaced between the first side edge 212 and the second side edge 214 of the window 104. Although two of the stabilizers 140, 141 are shown, a single stabilizer or three or more stabilizers may be used instead.

In an example implementation according to the foregoing description, the vehicle 100 includes a first vehicle body portion, such as the upper portion 126 of the door 120, and a second vehicle body portion, such as the lower portion 128 of the door 120, wherein the first vehicle body portion and the second vehicle body portion cooperate to define a window opening, such as the window opening 124. In this implementation, the window 904 includes the window surface 206 described with respect to the window 104, the bracket assemblies 130, 131 are connected to the window 904, and the guide structures 132, 133 are in engagement with the bracket assemblies 130, 131 so that the bracket assemblies 130, 131 are movable with respect to the guide structures 132, 133 to allow movement of the window 904 between a closed position and an open position. In this implementation, the stabilizer 140 is connected to the door 120 and engages the window surface 206 of the window 904 when the window 904 is in the open position. In this implementation the seal 216 of the window engages the upper portion 126 of the door 920 and the lower portion 128 of the door 920 when the window 904 is in the closed position.

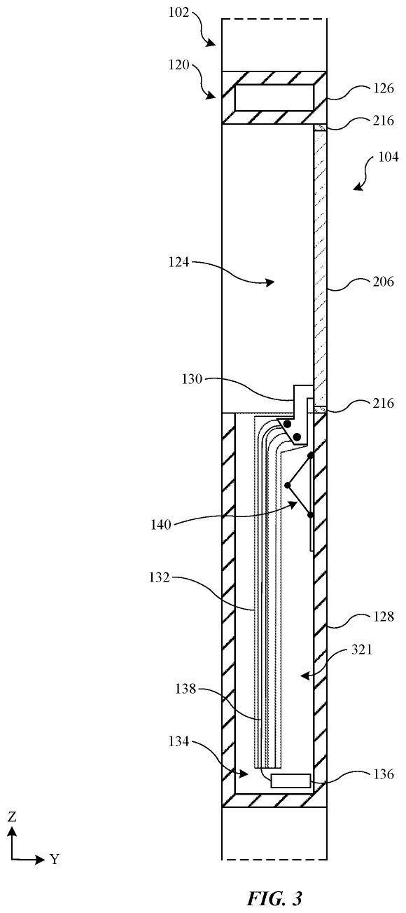

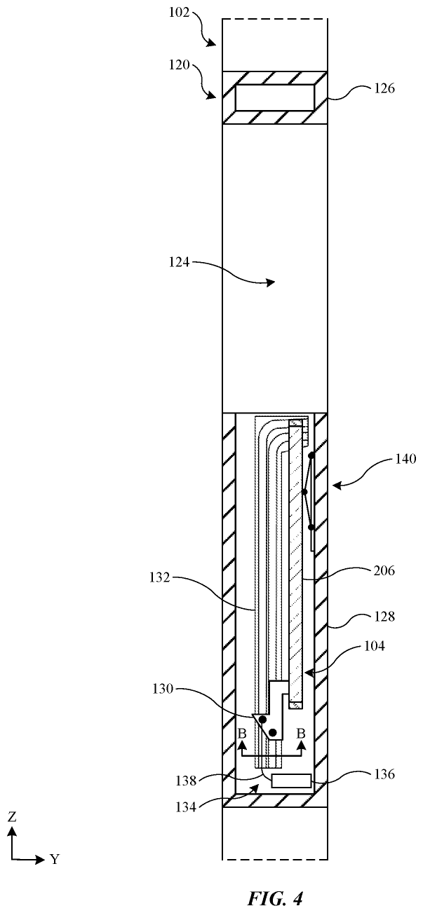

FIG. 3 is a cross-section illustration of the vehicle 100 taken along line A-A of FIG. 1 showing the window 104 in the closed position. FIG. 4 is a cross-section illustration of the vehicle 100 taken along line A-A of FIG. 1 showing the window 104 in the open position. In the closed position, the window 104 is located in and occupies the window opening 124.

The window 104 is movable between the closed position, in which the window 104 is located in and obstructs the window opening 124, and the open position, in which the window 104 has moved from the window opening 124 and into an interior space 321 of the door 120, for example, by moving inward (e.g., in the lateral direction Y of the vehicle 100) and then downward (e.g., in the elevational direction Z of the vehicle 100). In the closed position, the window opening 124 is fully occupied by the window 104. The seal 216 is in engagement with the portions of the vehicle body 102 that define the window opening 124 in the closed position, which includes the upper portion 126 of the door 120 and the lower portion 128 of the door 120 in the illustrated implementation. In the open position, at least a portion of the window opening 124 is not occupied by the window 104, and a part of or all of the window 104 is located inside the door 120.

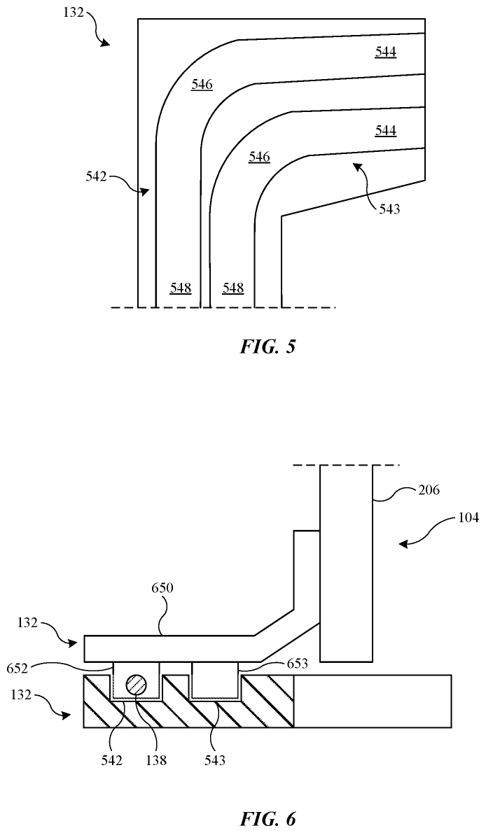

During movement of the window 104 between the closed position and the open position, the bracket assemblies 130, 131 move along the guide structures 132, 133, such as by sliding. The geometric features of the guide structures 132, 133 interact with the bracket assemblies 130, 131 to control the path (e.g., including translation and/or rotation) of the window 104 during movement between the closed and open positions. Interaction of the bracket assemblies 130, 131 and the guide structures will be explained further with reference to FIG. 5, which is an illustration showing part of the guide structure 132, and FIG. 6, which is a cross-section view of the guide structure 132 and the bracket assembly 130 taken along line B-B of FIG. 3. The bracket assembly 130 and the guide structure 132 are representative of the bracket assembly 131 and the guide structure 133, which may be implemented similarly.

The guide structure 132 includes a first guide 542 and a second guide 543. The first guide 542 and the second guide 543 function to control motion of the bracket assembly 130 with respect to the guide structure 132 so that the motion of the window 104 is constrained to follow the path defined by the guide structures 132, 133. In the illustrated implementation, the first guide 542 and the second guide 543 are tracks that are defined by depressions (e.g., elongate trough-like depressions) formed on the guide structure 132. The first guide 542 and the second guide 543 may be formed differently in other implementations, such as in the form of elongate projections, rails, wires, etc., that are configured to guide and constrain motion of the bracket assembly 130.

The first guide 542 and the second guide 543 are configured so that initial motion of the window 104 away from the closed position includes inward translation of the window 104 (e.g., translation in the lateral direction Y of the vehicle 100 in the illustrated implementation) and/or rotation of the window 104 so that a lower end of the window 104 swings inward relative to an upper end of the window 104. This initial inward motion is followed by a transition to generally downward motion of the window 104 (e.g., motion primarily in the elevational direction Z of the vehicle 100) to move the window 104 into the interior space 321 of the door 120. In the illustrated implementation, the first guide 542 and the second guide 543 each have a geometric profile that includes a first portion 544, a second portion 546, and a third portion 548. The first portions 544 of the first guide 542 and the second guide 543 are located near an upper end of the guide structure 132, and the bracket assembly 130 is located along the first portion 544 when the window 104 is in the closed position. The first portions 544 are configured to guide inward translation and/or rotation of the window 104 as it begins movement from the closed position toward the open position and outward translation and/or rotation during movement from the open position toward the closed position. The second portions 546 of the first guide 542 and the second guide 543 are located inward from the first portions 544 and, in the illustrated implementation, are curved portions of the first guide 542 and the second guide 543 that are configured to transition the window 104 from generally lateral motion in the first portions 544 to generally elevational motion in the third portions 548, which are located downward from the second portions 546 and correspond to the location of the bracket assembly 130 when the window 104 is in the open position.

To engage the bracket assembly 130 with the guide structure 132 so that the bracket assembly 130 moves in accordance with the geometric configuration of the first guide 542 and the second guide 543, the bracket assembly 130 includes body portion 650, a first follower 652, and a second follower 653. The body portion 650 is connected to the window 104 (e.g., by an adhesive) and is engaged with the guide structure 132 through the first follower 652 and the second follower 653. The first follower 652 is connected to the body portion 650 and is movable along the first guide 542. The second follower 653 is connected to the body portion 650 and is movable along the second guide 543. The first follower 652 and the second follower 653 may be any type of structure that is able to move along the first guide 542 and the second guide 543 while allowing rotation of the bracket assembly 130 with respect to the guide structure 132. As one example, the first follower 652 and the second follower 653 may be projections (e.g., cylindrical projections) that are either connected to or formed on the bracket assembly 130 and extend outward from the bracket assembly 130 into the engagement with (e.g., disposed in) the first guide 542 and the second guide 543. As another example, the first follower 652 and the second follower 653 may be rollers that are connected to the bracket assembly 130 and extend outward from the bracket assembly 130 into the engagement with (e.g., disposed in) the first guide 542 and the second guide 543.

To cause movement of the bracket assembly 130 along the guide structure 132, the push-pull cable 138 is connected to the bracket assembly 130. Thus, the bracket assembly 130 moves with respect to the guide structure 132 in response to extension and retraction of the push-pull cable 138 by the actuator. The push-pull cable 138 may be connected to the bracket assembly 130. As an example, the push-pull cable 138 may be connected to the bracket assembly 130 by a cam to avoid binding of the push-pull cable 138. The push-pull cable 139 causes motion of the bracket assembly 131 with respect to the guide structure 133 in the same manner.

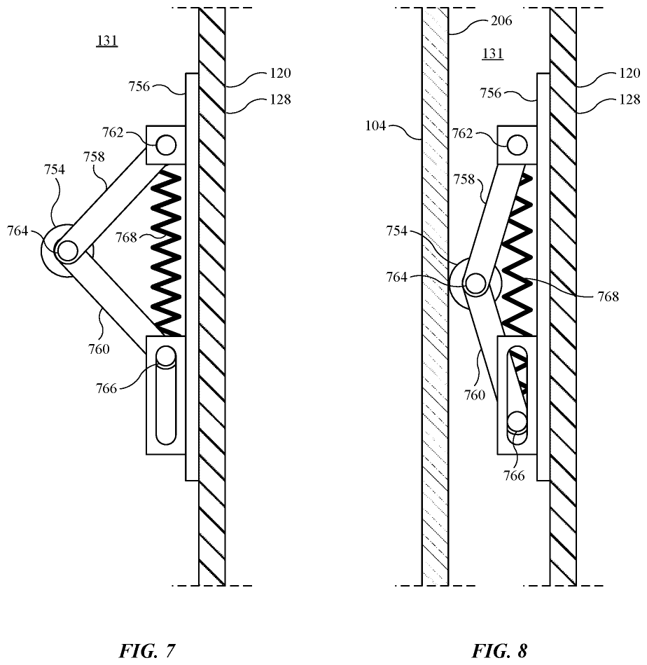

FIG. 7 is a cross-section illustration showing the stabilizer 140 according to an example implementation when the window 104 is in the closed position, and FIG. 8 is a cross-section illustration showing the stabilizer 140 when the window 104 is in the open position. The stabilizer 140 is connected to a portion of the vehicle body 102. In the illustrated implementation, the stabilizer 140 is connected to the lower portion 128 of the door 120 and is located in the interior space 321 of the door 120. The stabilizer 140 engages the window surface 206 of the window 104 when the window 104 is in the open position and applies a force to the window 104. In the illustrated example, the stabilizer 140 include a contact member 754 that is biased toward engagement with the window surface of the window 104 when the window 104 is in the open position to apply force to the window 104.

Engagement of the stabilizer 140 restrains motion of the window 104 with respect to the door 120 when the window 104 is in the open position. Stabilizing the window 104 with respect to the door 120 may reduce unintended motion of the window 104 resulting from the bracket assemblies 130, 131 providing primary support to the window 104 adjacent to the lower edge 210 of the window 104. Thus, for example, the stabilizer 140 may engage the window 104 at a location above a vertical midpoint of the window 104 when the window 104 is disposed entirely within the interior space 321 of the door 120, while the bracket assemblies 130, 131 support the window 104 below the vertical midpoint of the window 104 and the window 104 is otherwise free from support above the vertical midpoint of the window 104.

In the illustrated implementation, the stabilizer 140 includes a bracket 756 and a mechanical linkage that supports the contact member 754 so that it is movable with respect to the bracket. The mechanical linkage includes a first link 758 and a second link 760. The first link 758 extends between a first pivot joint 762 (e.g., a pin) and a second pivot joint 764, where the first pivot joint 762 connects the first link 758 to the bracket 756, and the second pivot joint 764 connects the first link 758 to the second link 760. The contact member 754 may be connected to the second pivot joint 764 or may be connected to the mechanical linkage adjacent to the second pivot joint 764, such as by connection to the first link 758 or the second link 760. The second link 760 extends from the second pivot joint to a sliding pivot joint 766 (e.g., a pin in a slot) that connects the second link to the bracket 756. The sliding pivot joint 766 allows sliding with respect to the bracket 756, which corresponds to movement of the contact member 754. In particular, the sliding pivot joint 766 slides away from the first pivot joint 762 when the contact member 754 is moved toward the bracket, and the sliding pivot joint 766 slides toward the first pivot joint 762 when the contact member 754 is moved away from the bracket 756. The contact member 754 is spring biased away from the bracket 756 to bias the contact member 754 into engagement with the window 104 when the window 104 is in the open position. In the illustrated example, a spring 768 (e.g., a tension spring in the illustrated implementation) is connected to the sliding pivot joint 766 and to a fixed point, such as the bracket 756 or the first pivot joint 762, to bias the sliding pivot joint toward the first pivot joint 762. Thus, when the window 104 is moved toward the closed position from the open position, the contact member 754 is displaced in opposition to the biasing force of the spring 768 (FIG. 8) and the contact member 754 returns to its original position when the window 104 returns to the closed position (FIG. 7).

Other structures may be used to support the contact member 754 so that it is biased toward engagement with the window 104, such as a compression spring that is arranged linearly between the door 120 and the contact member 754 or a single link that supports the contact member 754 and is biased by a torsion spring.

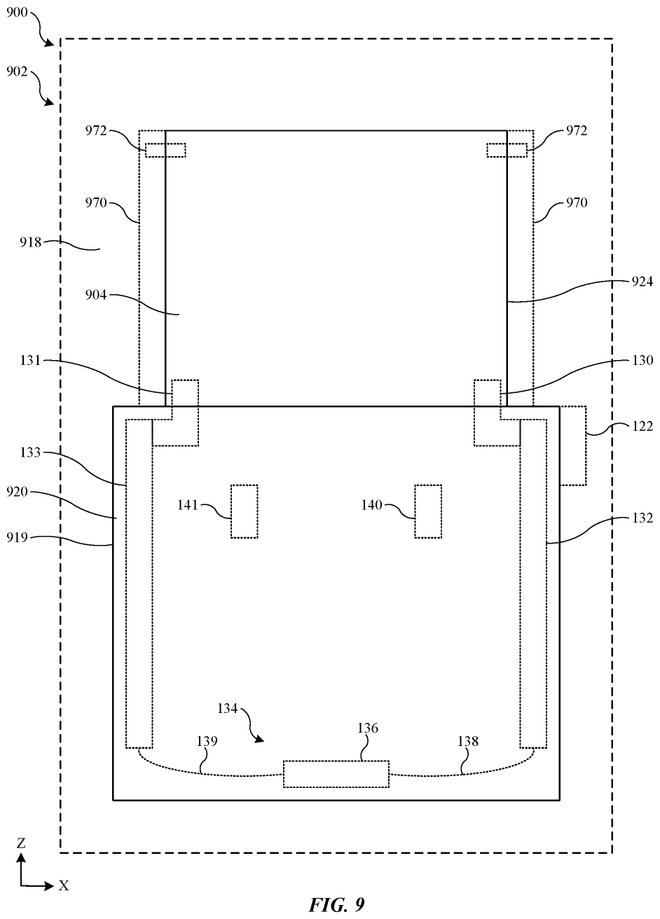

FIG. 9 is an illustration of part of a vehicle 900 that includes a vehicle body 902 and shows a window 904 in a closed position. The vehicle 900 is an alternative implementation of the vehicle 100 of FIG. 1. The description of the vehicle 100 is applicable to the vehicle 900 except as noted and like-numbered parts are as previously described.

The vehicle body 902 includes a door 920 that omits the upper portion 126 of the door 120 and instead uses a frameless window design in which a window opening 924 is defined by a side portion 918 (e.g., a vehicle body portion) of the vehicle body 902 and the door 920, with the door 920 being adjacent to a lower edge of the window 904 and the side portion 918 being adjacent to a top edge and side edges of the window 904. As an example, the side portion 918 may be or include a door pillar that defines part of a door opening 919 and/or the part of the window opening 924 and is therefore adjacent to the door 920 and/or the window 904. The window 904 is flush relative to portions of the side portion 918 of the vehicle body 902 and the door 920 in the closed position. For example, the window 104 may be flush relative to a first vehicle body surface portion that is defined on the side portion 918 of the vehicle body 902 and may be flush relative to a second vehicle body surface portion that is defined on the door 920 in the closed position.

Upper guides 970, such as tracks, may be connected to or formed on the side portion 918 adjacent to the window 904. Engaging structures 972 (e.g., pins or rollers) are engaged with to the upper guides 970 to support the upper end of the window 904. The engaging structures 972 are configured to slide along the upper guides 970 during movement of the window from the closed position to the open position, and, for example, pass out of lower ends of the upper guides 970 as the window 904 fully enters the door 920. To open the door 920 with the window 904 in the closed position, the engaging structures may disengage from the upper guides 970, such as by retracting or pivoting.

In an example implementation according to the foregoing description, the vehicle 900 includes a first vehicle body portion, such as the side portion 918 of the vehicle body 902, and a second vehicle body portion, such as the door 120, wherein the first vehicle body portion and the second vehicle body portion cooperate to define a window opening, such as the window opening 924. In this implementation, the window 104 includes the window surface 206, the bracket assemblies 130, 131 are connected to the window 104, and the guide structures 132, 133 are in engagement with the bracket assemblies 130, 131 so that the bracket assemblies 130, 131 are movable with respect to the guide structures 132, 133 to allow movement of the window 104 between a closed position and an open position. In this implementation, the stabilizer 140 is connected to the lower portion 128 of the door 120 and engages the window surface 206 of the window 104 when the window 104 is in the open position. In this implementation the seal 216 of the window engages the side portion 918 of the vehicle body 902 and the door 920 when the window 904 is in the closed position.

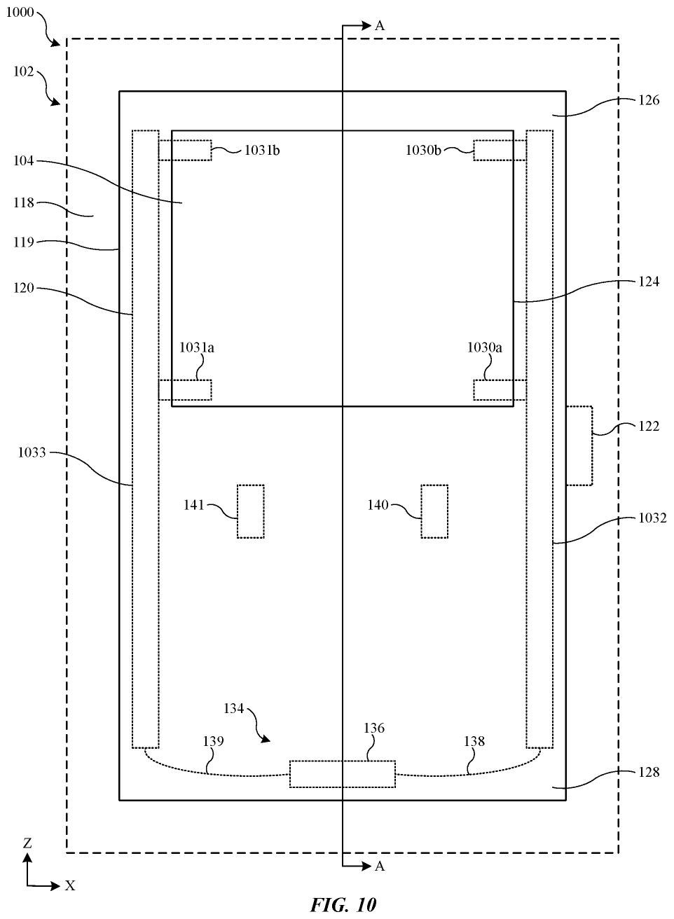

FIG. 10 is an illustration of part of a vehicle 1000. The vehicle 1000 is an alternative implementation of the vehicle 100 of FIG. 1. The description of the vehicle 100 is applicable to the vehicle 1000 except as noted and like-numbered parts are as previously described.

The vehicle 100 includes guide structures 1032, 1033 that extend from a bottom end near a lower end of the door 120 to a top end near an upper end of the door 120 (e.g., to an elevational position adjacent to a top edge of the window 104. The guide structures 1032, 1033 are otherwise implemented in the manner described with respect to the guide structures 132, 133.

The vehicle 100 also includes lower bracket assemblies 1030a, 1031a that are equivalent to the bracket assemblies 130, 131 and are connected to the window 104 near a lower end of the window 104. The vehicle 100 also includes upper bracket assemblies 1030b, 1031b that are similar to the bracket assemblies 130, but are connected to the window 104 near a lower end of the window 104 and are connected to the guide structures 1032, 1033 near their upper ends. Movement of the window 104 is otherwise similar to the previous description, with the lower bracket assemblies 1030a, 1031a and the upper bracket assemblies 1030b, 1031b moving along the guide structures 1032, 1033 during movement of the window 104. The stabilizers 140, 141 may be included in this implementation or may be omitted because of the additional support provided by the upper bracket assemblies 1030b, 1031b.

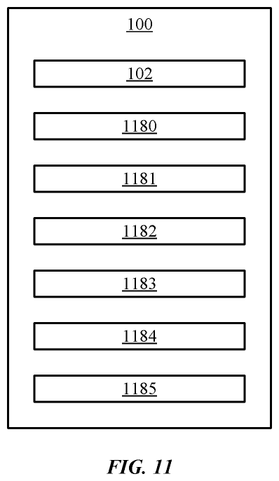

FIG. 11 is a block diagram that shows the vehicle 100. As an example, the vehicle 100 may be a conventional road-going vehicle that is supported by wheels and tires (e.g., four wheels and tires). As an example, the vehicle 100 may be a passenger vehicle that includes a passenger compartment that is configured to carry one or more passengers. In the illustrated implementation, the vehicle 100 includes the vehicle body 102, a suspension system 1180, a propulsion system 1181, a braking system 1182, a steering system 1183, a sensing system 1184, and a control system 1185. These are examples of vehicle systems that are included in the vehicle 100. Other systems can be included in the vehicle 100.

The vehicle body 102 includes structural components of the vehicle 100 through which other components are interconnected and supported as well as aesthetic components of the vehicle 100. The structural components of the vehicle body 102 may include, as examples, a frame, subframe, unibody, monocoque, etc. The aesthetic components of the vehicle body 102 may include exterior body panels, exterior trim panels, interior trim panels, fixtures, accessories, etc.

The suspension system 1180 controls vertical motion of the wheels of the vehicle 100 relative to the vehicle body 102, and may include passive suspension components and/or active suspension components. The propulsion system 1181 includes propulsion components that are configured to cause motion of the vehicle 100 (e.g., accelerating the vehicle 100), such as an internal combustion engine, one or more electric motors, a battery, an inverter, one or more gearboxes, etc. The braking system 1182 provides deceleration torque for decelerating the vehicle 100. The steering system 1183 is operable to cause the vehicle to turn by changing a steering angle of one or more wheels of the vehicle 100.

The sensing system 1184 includes sensors for observing external conditions of the environment around the vehicle 100 (e.g., location of the roadway and other objects) and conditions of the vehicle 100 (e.g., acceleration and conditions of the various systems and their components). The sensing system 1184 may include sensors of various types, including dedicated sensors and/or components of various systems.

The control system 1185 includes communication components (i.e., for receiving sensor signals and sending control signals) and processing components (i.e., for processing the sensor signals and determining control operations), such as a controller. The control system 1185 may be a single system or multiple related systems. For example, the control system 1185 may be a distributed system including components that are included in other systems of the vehicle 100.

The control system 1185 may include autonomous driving functions that are configured to control operation of vehicle actuator systems of the vehicle 100 without manual control inputs. As an example, the control system 1185 may use inputs received from the sensing system 1184 to understand the environment around the vehicle and may determine commands that are sent to one or more vehicle actuator systems, such as the propulsion system 1181, the braking system 1182, and the steering system 1183, to cause the vehicle 100 to travel from a current location toward a destination location.

The control system 1185 may exercise control over various systems and components of the vehicle 100, including controlling movement of the window 104 and/or the door 120.

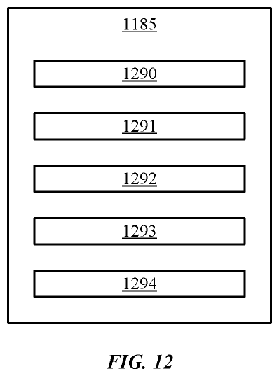

FIG. 12 is a block diagram that shows an example implementation of the control system 1185 and/or other computer-implemented systems of the vehicle 100. The control system 1185 may be a conventional computing device that includes include a processor 1290, a memory 1291, a storage device 1292, one or more input devices 1293, and one or more output devices 1294. The control system 1185 may include a bus or a similar device to interconnect the components for communication. The control system 1185 may include computer program instructions (e.g., stored on the storage device 1292) that are configured to cause the control system to perform the computer-implemented functions described herein with respect to the vehicle 100 and various systems thereof.

The processor 1290 is operable to execute computer program instructions and perform operations described by the computer program instructions. As an example, the processor 1290 may be a conventional device such as a central processing unit. The memory 1291 may be a volatile, high-speed, short-term information storage device such as a random-access memory module. The storage device 1292 may be a non-volatile information storage device such as a hard drive or a solid-state drive. The input devices 1293 may include any type of human-machine interface such as buttons, switches, a keyboard, a mouse, a touchscreen input device, a gestural input device, or an audio input device. The output devices 1294 may include any type of device operable to provide an indication to a user regarding an operating state, such as a display screen or an audio output, or any other functional output or control.

What is claimed is:

1. A vehicle, comprising:
a first vehicle body portion;
a second vehicle body portion, wherein the first vehicle body portion and the second vehicle body portion cooperate to define a window opening;
a window that has window surface;
bracket assemblies that are connected to the window;
guide structures that are in engagement with the bracket assemblies so that the bracket assemblies are movable with respect to the guide structures to allow movement of the window between a closed position and an open position; and
a stabilizer that is connected to the second vehicle body portion and engages the window surface of the window when the window is in the open position.

2. The vehicle of claim 1, wherein the stabilizer includes a contact member that is biased toward engagement with the window surface of the window when the window is in the open position.

3. The vehicle of claim 1, wherein the guide structures include a first guide structure and a second guide structure, wherein the stabilizer is located between the first guide structure and the second guide structure.

4. The vehicle of claim 1, wherein the second vehicle body portion defines an interior space, the guide structures are located inside the interior space of the second vehicle body portion, the stabilizer is located inside the interior space of the second vehicle body portion, and the window is located inside the second vehicle body portion when the window is in the open position.

5. The vehicle of claim 1, wherein the guide structures each include a first guide and a second guide, and the bracket assemblies each include a first follower that is movable along the first guide and a second follower that is movable along the second guide.

6. The vehicle of claim 5, wherein the first guide and the second guide of each of the guide structures are tracks.

7. The vehicle of claim 1, wherein the first vehicle body portion is an upper portion of a door and the second vehicle body portion is a lower portion of the door.

8. The vehicle of claim 1, wherein the first vehicle body portion includes a door pillar and the second vehicle body portion is a door.

9. The vehicle of claim 1, wherein the window includes a panel that is at least translucent and a seal, the seal is located along a peripheral edge of the window, and the seal is in engagement with the first vehicle body portion and the second vehicle body portion when the window is in the closed position.

10. The vehicle of claim 1, further comprising:
an actuation assembly that is configured to cause movement of the window between the closed position and the open position.

11. The vehicle of claim 1, wherein:
the second vehicle body portion defines an interior space,
the guide structures are located inside the interior space of the second vehicle body portion,
the guide structures each include a first guide and a second guide,
the bracket assemblies each include a first follower that is movable along the first guide of a respective one of the guide structures and a second follower that is movable along the second guide of the respective one of the guide structures,
the guide structures include a first guide structure and a second guide structure, and the
stabilizer is located between the first guide structure and the second guide structure,
the stabilizer is located inside the interior space of the second vehicle body portion, the stabilizer includes a contact member that is biased into engagement with the window surface of the window when the window is in the open position,
the window is located inside the second vehicle body portion in the open position,
the window includes a panel that is at least translucent and a seal that is located along a peripheral edge of the window, and the seal is in engagement with the first vehicle body portion and the second vehicle body portion when the window is in the closed position, and
the first vehicle body portion includes a first body surface portion, the second vehicle body portion includes a second body surface portion, and the window surface of the window is flush relative to the first body surface portion and the second body surface portion when the window is in the closed position.

12. A vehicle, comprising:
a door that defines a window opening and an interior space;
a window that has window surface, wherein the window is movable with respect to the door between a closed position and an open position, the window occupies the window opening when the window is in the closed position, and the window is located inside the interior space of the door when the window is in the open position;
a first bracket assembly and a second bracket assembly;
a first guide structure and a second guide structure, wherein the first bracket assembly moves along the first guide and the second bracket assembly moves along the second guide during movement of the window between the closed position and the open position;
an actuation assembly that is configured to cause movement of the window between the closed position and the open position; and
a stabilizer that is connected to the door and engages the window surface of the window when the window is in the open position.

13. The vehicle of claim 12, wherein the stabilizer includes a contact member that is biased toward engagement with the window surface of the window when the window is in the open position.

14. The vehicle of claim 12, wherein the stabilizer is located between the first guide structure and the second guide structure.

15. The vehicle of claim 12, wherein the stabilizer is located inside the interior space of the door.

16. The vehicle of claim 12, wherein the first bracket assembly and the second bracket assembly each include followers, the first guide structure and the second guide structure each include guides, the followers of each of the first bracket assembly and the second bracket assembly are in engagement with the guides of a respective one of the first guide structure and the second guide structure to allow movement of the first bracket assembly and the second bracket assembly with respect to the first guide structure and the second guide structure.

17. The vehicle of claim 12, wherein the door defines a door surface portion and the window surface of the window is flush relative to the door surface portion when the window is in the closed position.

18. A vehicle, comprising:
a vehicle body portion that defines a door opening;
a door that defines an interior space, wherein the door is connected to the vehicle body portion, the door is positionable in the door opening, and the vehicle body portion and the door cooperate to define a window opening;
a window that is movable between a closed position and an open position;
bracket assemblies that are connected to the window;
guide structures that are located in the interior space of the door, wherein the bracket assemblies move along the guide structures during movement of the window between the closed position and the open position;
an actuation assembly that is configured to cause movement of the window between the closed position and the open position; and
a stabilizer that is connected to the door and engages a window surface of the window when the window is in the open position.

19. The vehicle of claim 18, wherein the stabilizer includes a contact member that is biased toward engagement with the window surface of the window when the window is in the open position.

20. The vehicle of claim 18, wherein the stabilizer is located inside the interior space of the door.

21. The vehicle of claim 18, wherein the guide structures each include a first track and a second track, the bracket assemblies each include a first follower that engages the first track of a respective one of the guide structures and a second follower that engages the second track of the respective one of the guide structures.

22. The vehicle of claim 18, wherein the vehicle body portion includes a body surface portion, the door includes a door surface portion, and the window surface of the window is flush relative to the body surface portion and the door surface portion when the window is in the closed position.
